(19) United States
(12) Patent Application Publication
(10) Pub. No.: US 2009/0080803 A1
(43) Pub. Date: Mar. 26, 2009

(54) IMAGE PROCESSING PROGRAM, COMPUTER-READABLE RECORDING MEDIUM RECORDING THE PROGRAM, IMAGE PROCESSING APPARATUS AND IMAGE PROCESSING METHOD

(76) Inventors: Mitsugu HARA, Tokyo (JP); Kazuhiro Matsuta, Tokyo (JP); Paku Sugiura, Tokyo (JP); Daisuke Tabayashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/233,203

(22) Filed: Sep. 18, 2008

(30) Foreign Application Priority Data
Sep. 20, 2007 (JP) 2007-244287
Dec. 21, 2007 (JP) 2007-329872

(51) Int. Cl. G06K 9/36

(52) U.S. Cl. 382/285

(57) ABSTRACT

Provided is a program that is executed by an image processing apparatus including a memory and a processor, and which generates two-dimensional image data obtained by performing perspective projection to a virtual three-dimensional space on a prescribed perspective projection plane. The program causes the processor to perform processes of (a) arranging a viewpoint in the virtual three-dimensional space, generating basic image data by performing perspective projection on the perspective projection plane set in correspondence to the viewpoint, and storing the basic image data in the memory; (b) setting a concentration map showing a concentration value associated with a partial region of the basic image data, and storing the concentration map in the memory; (c) reading texture data from the memory; and (d) generating the two-dimensional image data by synthesizing the texture data with the basic image data at a ratio according to the concentration value set with the concentration map.

### CROSS-REFERENCES TO RELATED APPLICATIONS

The entire disclosure of Japanese Patent Application No. 2007-244287, filed on Sep. 20, 2007, is expressly incorporated by reference herein. The entire disclosure of Japanese Patent Application No. 2007-329872, filed on Dec. 21, 2007, is expressly incorporated by reference herein.

### BACKGROUND

1. Technical Field

The present, invention generates a two-dimensional image by performing perspective projection conversion to an event set in a virtual three-dimensional space.

2. Related Art

Pursuant to the development of computer technology in recent years, image processing technology related to video game machines and simulators is now universally prevalent. With this kind of system, increasing the expressiveness of the displayed images is important in increasing the commercial value. Under these circumstances, in a clear departure from a more realistic expression (graphic expression), the expression of handwriting style images in the style of watercolors or sketches is being considered (for instance, refer to JP-A-2007-26111).

An actual water-color painting or the like is created by applying a coating compound (paint, charcoal, etc.) on a canvas. Here, as a result of the unpainted portion or uneven portion of the coating compound, there are many cases where the basic pattern under such portion becomes visible, and this is an important factor in projecting the atmosphere of a water-color painting or the like. Thus, when generating an image imitating a water-color painting or the like, the expression of the base pattern becomes important in order to improve the overall expressiveness. Accordingly, image processing technology capable of freely expressing the foregoing base pattern with a reasonable operation load is being anticipated.

### SUMMARY

Thus, an advantage of some aspects of the invention is to provide image processing technology capable of improving the expressiveness of handwriting style images.

An image processing program according to an aspect of the invention is executed by an image processing apparatus comprising a memory and a processor, and is a program for generating two-dimensional image data obtained by performing perspective projection to a virtual three-dimensional space on a prescribed perspective projection plane. This program causes the processor to perform processes of (a) arranging a viewpoint in the virtual three-dimensional space, generating basic image data by performing perspective projection on the perspective projection plane set in correspondence to the viewpoint, and storing the basic image data in the memory, (b) setting a concentration map showing a concentration value associated with a partial region of the basic image data, and storing the concentration map in the memory, (c) reading texture data from the memory, and (d) generating the two-dimensional image data by synthesizing the texture data with the basic image data at a ratio according to the concentration value set with the concentration map.

Preferably, at (b), data that demarcates the partial region and designates the concentration value of the partial region is read from the memory, and the concentration map is set based on the read data.

Preferably, at (b), the concentration map that demarcates the partial region and designates the concentration value of the partial region is set by arranging a semi-transparent model associated with the concentration value in the virtual three-dimensional space and rendering the semi-transparent model.

Preferably, the texture data includes an image of a canvas pattern. Here, a “canvas pattern” refers to a general pattern capable of simulatively expressing the surface of a canvas used in water-color paintings and the like and, for instance, is a pattern imitating the surface of a hemp cloth or the like.

A computer-readable recording medium according to another aspect of the invention is a recording medium recording the foregoing program of the invention. As described below, the invention can also be expressed as an image processing apparatus or an image processing method.

An image processing apparatus according to a further aspect of the invention comprises a memory and a processor, and is an image processing apparatus for generating two-dimensional image data obtained by performing perspective projection to a virtual three-dimensional space on a prescribed perspective projection plane. With this image processing apparatus, the processor functions respectively as (a) a unit that arranges a viewpoint in the virtual three-dimensional space, generates basic image data by performing perspective projection on the perspective projection plane set in correspondence to the viewpoint, and stores the basic image data in the memory, (b) a unit that sets a concentration map showing a concentration value associated with a partial region of the basic image data, and stores the concentration map in the memory, (c) a unit that reads texture data from the memory, and (d) a unit that generates the two-dimensional image data by synthesizing the texture data with the basic image data at a ratio according to the concentration value set with the concentration map.

An image processing method according to a still further aspect of the invention is an image processing method of generating two-dimensional image data obtained by performing perspective projection to a virtual three-dimensional space with an object arranged therein on a prescribed perspective projection plane in an image processing apparatus comprising a memory and a processor. With this image processing method, the processor performs processes of (a) arranging a viewpoint in the virtual three-dimensional space, generating basic image data by performing perspective projection on the perspective projection plane set in correspondence to the viewpoint, and storing the basic image data in the memory, (b) setting a concentration map showing a concentration value associated with a partial region of the basic image data, and storing the concentration map in the memory, (c) reading texture data from the memory, and (d) generating the two-dimensional image data by synthesizing the texture data with the basic image data at a ratio according to the concentration value set with the concentration map.

### BRIEF DESCRIPTION OF THE DRAWINGS

FIG. 1 is a block diagram showing the configuration of a game machine according to an embodiment of the invention;

FIG. 2 is a conceptual diagram showing the object (virtual object), light source, and viewpoint arranged in a virtual three-dimensional space;

FIG. 3 is a flowchart showing the flow of image processing to be executed by the game machine of the first embodiment;

FIG. 4 is a view showing a frame format of an example of basic image data;

FIG. 5 is a diagram visually expressing the contents of a concentration map;

FIG. 6 is a diagram explaining an example of texture data;

FIG. 7 is a diagram explaining the appearance of texture data that is synthesized at a ratio according to the concentration value;

FIG. 8 is a diagram showing the appearance when texture data and basic image data are synthesized;

FIG. 9 is a flowchart showing the flow of image processing to be executed by the game machine of the second embodiment;

FIG. 10 is a view showing a frame format explaining the processing contents of step S22;

FIG. 11 is a diagram visually expressing the concentration map to be set at step S23;

FIG. 12 is a diagram showing the appearance when texture data and basic image data are synthesized at a ratio according to the concentration value;

FIG. 13 is a diagram explaining a display image in a case of continually moving the position of the semi-transparent model;

FIG. 14 is a diagram showing an example of an image that combines the effects of the first processing in the first embodiment and the second processing in the second embodiment;

FIG. 15 is a flowchart showing the flow of image processing to be executed by the game machine of the third embodiment;

FIG. 16A to FIG. 16C are diagrams explaining the fog value;

FIG. 17 is a diagram visually expressing the concentration map to be set at step S33;

FIG. 18 is a diagram showing the appearance when texture data and basic image data are synthesized at a ratio according to the concentration value;

FIG. 19 is a flowchart showing the flow of image processing to be executed by the game machine of the fourth embodiment;

FIG. 20 is a conceptual diagram explaining the relationship of the respective polygons configuring the object, and the camera vector;

FIG. 21 is a diagram explaining a specific example of data conversion at step S43;

FIG. 22 is a diagram visually expressing the concentration map to be set at step S43;

FIG. 23 is a diagram showing the appearance when texture data and basic image data are synthesized at a ratio according to the concentration value;

FIG. 24 is a flowchart showing the flow of image processing to be executed by the game machine of the fifth embodiment;

FIG. 25 is a diagram visually showing the synthesized concentration map; and

FIG. 26 is a diagram showing the appearance when texture data and basic image data are synthesized at a ratio according to the concentration value.

### DESCRIPTION OF EXEMPLARY EMBODIMENTS

Embodiments of the invention are now explained. In the ensuing explanation, a game machine is taken as an example of the image processing apparatus.

### First Embodiment

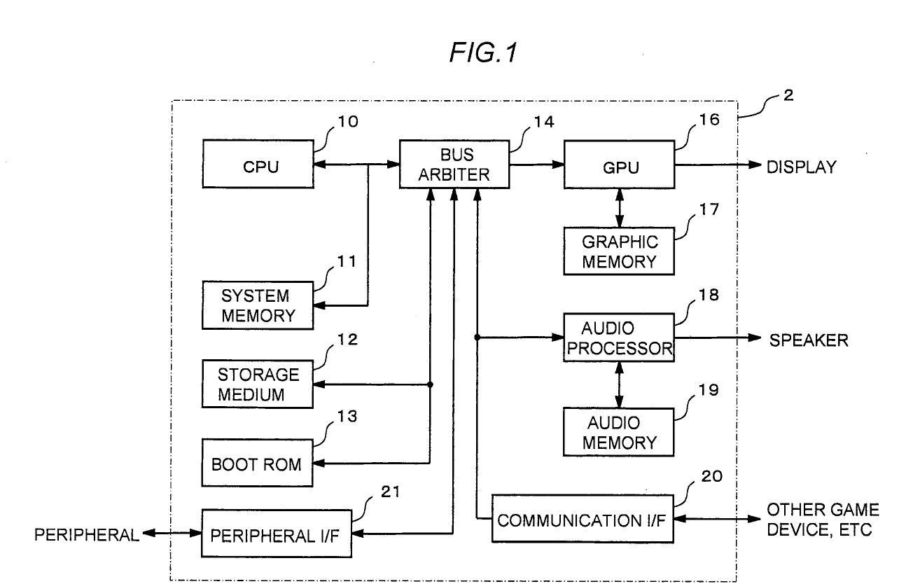

FIG. 1 is a block diagram showing the configuration of a game machine. The game machine 1 shown in FIG. 1 comprises a CPU (Central Processing Unit) 10, a system memory 11, a storage medium 12, a boot ROM (BOOT ROM) 13, a bus arbiter 14, a GPU (Graphics Processing Unit) 16, a graphic memory 17, an audio processor 18, an audio memory 19, a communication interface (I/F) 20, and a peripheral interface 21. Specifically, the game machine 1 of this embodiment comprises the CPU 10 and the GPU 16 as the arithmetic unit (processor), and comprises the system memory 11, the storage medium 12, the graphic memory 17 and the audio memory 19 as the storage unit (memory). In other words, the game machine 1 comprises a computer (computer system) configured from the CPU 10 and other components, and functions as a game machine by causing the computer to execute prescribed programs. Specifically, the game machine 1 sequentially generates a two-dimensional image viewed from a given viewpoint (virtual camera) in a virtual three-dimensional space (game space) and generates audio such as sound effects in order to produce a game presentation.

The CPU (Central Processing Unit) 10 controls the overall game machine 1 by executing prescribed programs.

The system memory 11 stores programs and data to be used by the CPU 10. The system memory 11 is configured from a semiconductor memory such as a DRAM (dynamic random access memory) or an SRAM (static random access memory).

The storage medium 12 stores a game program and data such as images and audio to be output. The storage medium 12 as the ROM for storing program data may be an IC memory such as a mask ROM or a flash ROM capable of electrically reading data, or an optical disk or a magnetic disk such as a CD-ROM or a DVD-ROM capable of optically reading data.

The boot ROM 13 stores a program for initializing the respective blocks upon starting up the game machine 1.

The bus arbiter 14 controls the bus that exchanges programs and data between the respective blocks.

The GPU 16 performs arithmetic processing (geometry processing) concerning the position coordinate and orientation of the object to be displayed on the display in the virtual three-dimensional space (game space), and processing (rendering processing) for generating an image to be output to the display based on the orientation and position coordinate of the object.

The graphic memory 17 is connected to the GPU 16, and stores data and commands for generating images. The graphic memory 17 is configured from a semiconductor memory such as a DRAM (dynamic random access memory) or a SRAM (static random access memory). The graphic memory 17 functions as the various buffers such as a frame buffer or a texture buffer upon generating images.

The audio processor 18 generates data for output audio from the speaker. The audio data generated with the audio processor 18 is converted into an analog signal with a digital/analog converter (not shown), and audio is output from the speaker as a result of such analog signal being input to the speaker.

The audio memory 19 is configured in the audio processor 18, and stores data and commands for generating audio. The audio memory 19 is configured from a semiconductor memory such as a DRAM (dynamic random access memory) or a SRAM (static random access memory).

The communication interface (I/F) 20 performs communication processing when the game machine 1 needs to engage in data communication with another game machine, a server apparatus or the like.

The peripheral interface (I/F) 21 has a built-in interface for inputting and outputting external data, and a peripheral is connected hereto as a peripheral device. Here, a peripheral includes components that can be connected to the image processing apparatus main body or another peripheral such as a mouse (pointing device), a keyboard, a switch used for the key operation of a game controller, a touch pen, as well as a backup memory for storing the progress of the program and the generated data, a display device, and a photographic device.

With respect to the system memory 11, the graphic memory 17, and the sound memory 19, one memory may be connected to the bus arbiter 14 and commonly used by the respective functions. In addition, since it will suffice if each function block exists as a function, the function blocks may be integrated or the respective constituent elements in the function block may be separated other blocks.

The game machine of this embodiment is configured as described above, and the contents of the image creation processing of this embodiment are now explained.

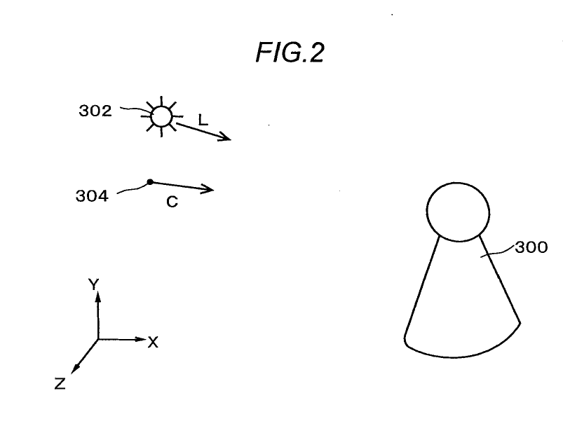

FIG. 2 is a conceptual diagram showing the object (virtual object), light source, and viewpoint arranged in the virtual three-dimensional space. The object 300 is a virtual object configured using one or more polygons. The object 300 may be any and all virtual objects that can be arranged in the virtual three-dimensional space including living things such as humans and animals, or inanimate objects such as buildings and cars. The virtual three-dimensional space is expressed with a world coordinate system defined with three axes (XYZ) that are mutually perpendicular. Moreover, the object 300 is expressed, for example, as an object coordinate system that is separate from the world coordinate system. The light source 302 is arranged at an arbitrary position in the virtual three-dimensional space. The light source 302 is an infinite light source or the like. The position, direction and intensity of the light source 302 are expressed with a light vector L. In this embodiment, the length (or optical intensity) of the light vector L is normalized as 1. The viewpoint (virtual camera) 304 is defined by the position (coordinates in the world coordinate system) and the visual line direction of the viewpoint, and expressed with a camera vector C.

Contents of the image processing to be executed by the game machine of this embodiment are now explained with reference to a flowchart. As the overall flow of image processing in this embodiment, upon arranging the object 300, the viewpoint 304, and the light source 302 (refer to FIG. 2), rendering processing (coordinate conversion, clipping, perspective projection conversion, hidden surface removal, shading, shadowing, texture mapping, etc.) is performed, and the processing concerning the expression of a canvas pattern shown below is further performed. Incidentally, with the processing explained below, the processing sequence may be switched or the respective processing steps may be performed in parallel so as long as there is no inconsistency in the processing result.

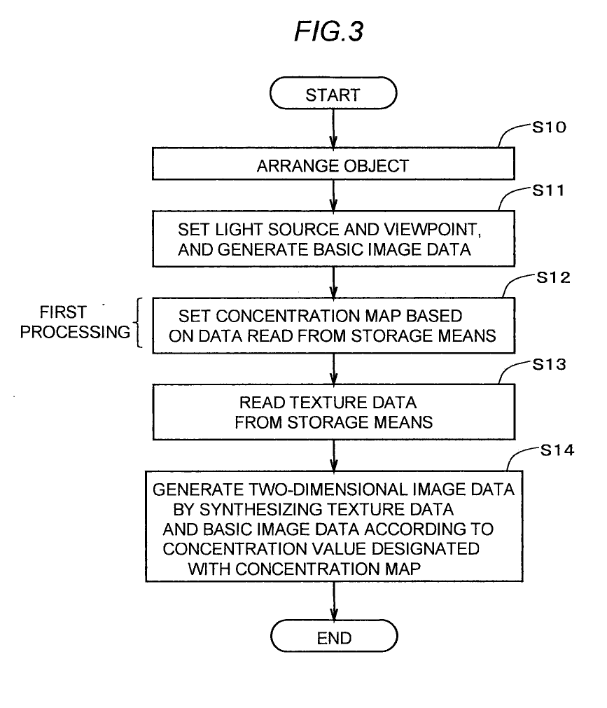

FIG. 3 is a flowchart showing the flow of image processing to be executed by the game machine of the first embodiment.

The CPU 10 arranges an object (polygon model) configured by combining a plurality of polygons in the virtual three-dimensional space based on the data read from the system memory 11 (step S10).

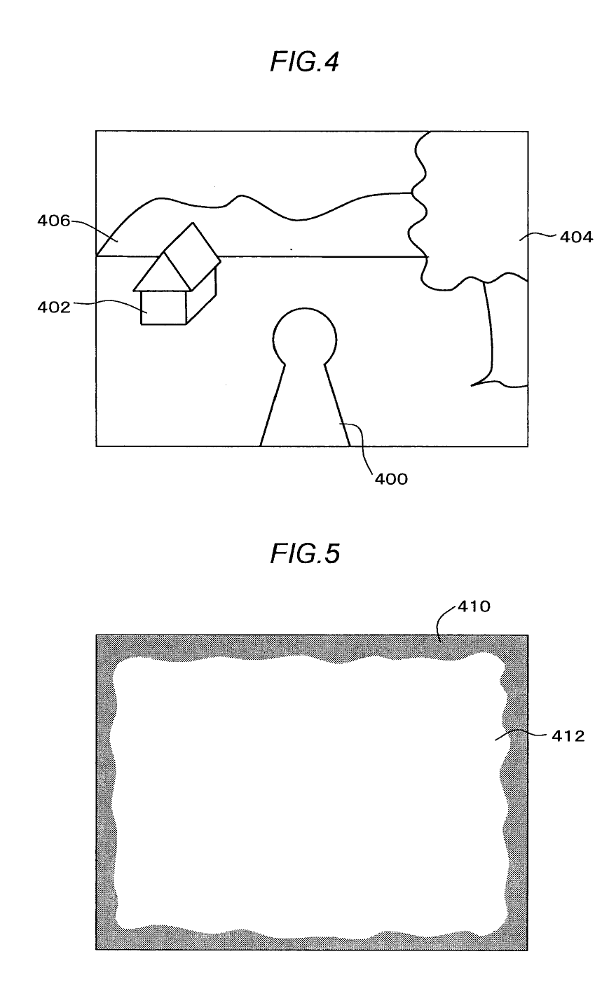

The CPU 10 additionally sets the light source and the viewpoint, and the GPU 16 generates basic image data according to the settings configured by the CPU 10 (step S11). The position of the viewpoint is set, for instance, at a position that is a constant distance behind the object operated by the player. The position of the light source, for example, is fixed at a prescribed position, or moves together with the lapse of time. The GPU 16 performs the processing (rendering processing) of coordinate conversion, clipping, perspective projection conversion, hidden surface removal and the like in correspondence to the respective settings of the light source and the viewpoint. Thereby, obtained is an image resulting from performing perspective projection to a virtual three-dimensional space with an object arranged therein on a perspective projection plane. In this embodiment, data of this image is referred to as “basic image data.” The basic image data is stored in a frame buffer (first storage area) set in the graphic memory 17. FIG. 4 is a view showing a frame format of an example of such basic image data. The basic image data shown in FIG. 4 includes a character image 400, a building image 402, a tree image 404, and a distant view image 406. Although texture mapping is performed to each object (character, building, tree, distant view) as needed, the expression thereof is omitted as a matter of practical convenience in the ensuing explanation.

Subsequently, the GPU 16 sets a concentration map based on the data read from the storage medium 12 (step S12). A concentration map is data showing a concentration value associated with at least a partial region in the basic image data. The set concentration map is stored in a texture buffer (second storage area) set in the graphic memory 17.

FIG. 5 is a diagram visually expressing the contents of a concentration map. In FIG. 5, an annular region 410 provided in correspondence with the outer periphery of the basic image data is shown with color. In this example, the concentration map shows the concentration value associated with the annular region 410. Specifically, the concentration value is set, for example, within a numerical value range of 0.0 to 1.0. A concentration value of 0.0 represents non-transmittance (opaque), a concentration value of 1.0 represents total transmittance (transparent), and a concentration value in between represents partial transmittance (semi transparent). The concentration value is set, for example, for each pixel. In the colored region in FIG. 5, as the concentration value, a constant value may be set to all pixels, and a different value may be set according to the position of the pixel. The storage medium 12 stores in advance, for example, two-dimensional data having the same size as the basic image data, and in which a concentration value of 0.0 to 1.0 is set for each pixel. Here, referring to the non-colored region 412 (region shown in white) on the inside of the colored annular region 410 in FIG. 5, for instance, the concentration value of each pixel in this region is set to 0.0. The concentration map shown in FIG. 5 can be set by reading this kind of two-dimensional data.

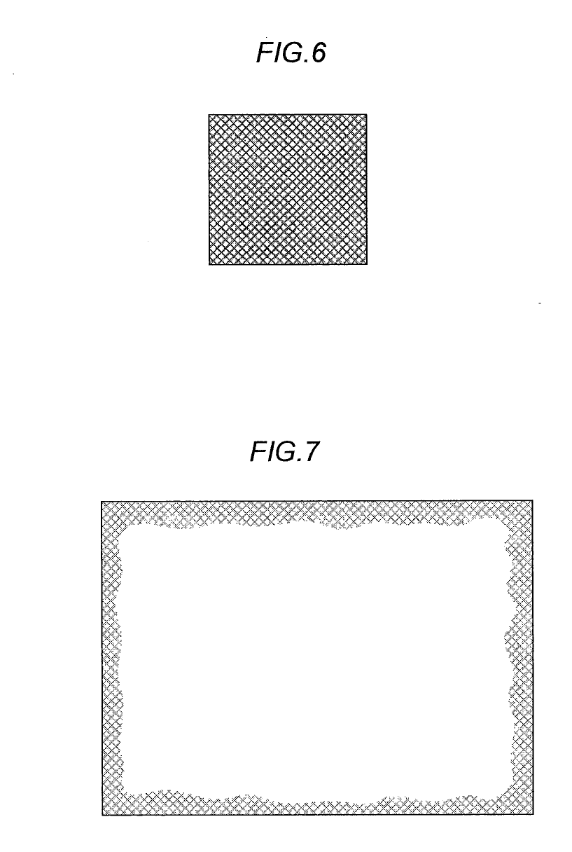

Subsequently, the GPU 16 reads texture data from the storage medium 12 (step S13). FIG. 6 is a diagram explaining an example of texture data. Texture data is image data including an arbitrary pattern. In this embodiment, texture data includes an image suitable for expressing a canvas pattern. For instance, this would be an image including a pattern imitating a blanket texture pattern as shown in FIG. 6.

Subsequently, the GPU 16 generates two-dimensional image data by synthesizing the texture data read at step S13 with the basic image data at a ratio according to the concentration value set with the concentration map set at step S12 (step S14). The generated two-dimensional image data is stored in a frame buffer set in the graphic memory 17.

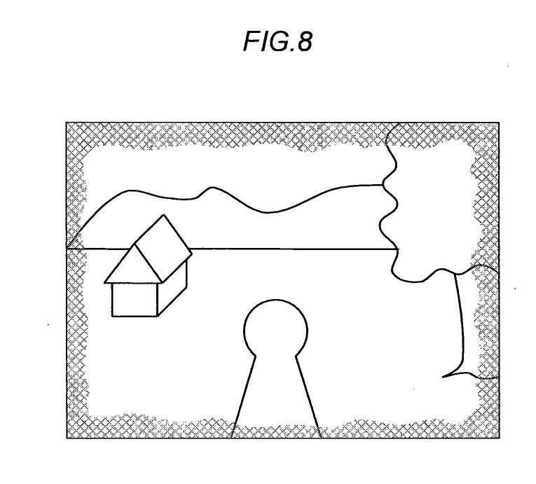

FIG. 7 is a diagram explaining the appearance of the texture that is synthesized at a ratio according to the concentration value. The expression “synthesize at a ratio according to the concentration value” means, for example, if the concentration value is 0.5, the texture data and the basic image data are mixed in the annular region 410 at a ratio of 50/50. Here, as shown in FIG. 7, the texture will have a concentration value that is lower than the original concentration value (refer to FIG. 6). FIG. 8 is a diagram showing the appearance when texture data and basic image data are synthesized. The texture data is synthesized in the annular region 410 at the periphery of the basic image data. The basic image is transmissive at a ratio according to the concentration value, and the texture is also semi transparent. If the user wishes to display the texture more thickly (darkly), the user sets the concentration value closer to 1.0. Consequently, since the transmittance of the basic image will decrease and the texture will be displayed more darkly, it is possible to enhance the unpainted feeling. If the concentration value is set to 1.0, since the texture data will be mixed at a ratio of 100% and the basic image data will be mixed at a ratio of 0%, the result will be that the basic image will not be transmissive and only the texture will be displayed. Here, the unpainted feeling in the annular region 410 will be accentuated the strongest. Meanwhile, if the user wishes to display the texture more thinly (lightly), the user sets the concentration value closer to 0.0. Consequently, since the transmittance of the basic image will increase and the texture will be displayed more lightly, the unpainted feeling will weaken. In other words, by appropriately setting the concentration value, it is possible to control the blend ratio of the texture data including the canvas pattern to the basic image data, and thereby freely control the unpainted feeling. Moreover, by setting the concentration value in detail for each pixel rather than as a constant value, the unpainted feeling can be expressed more delicately. In addition, by repeating the processing shown in FIG. 3 at a prescribed timing, it is possible to generate a moving image in which the unpainted feeling that changes occasionally in accordance with the respective scenes.

In this embodiment, although an annular region was described as an example of the “partial region in the basic image data,” the method of setting the region is not limited thereto. Further, FIG. 6 is merely an example of a pattern including texture data, and the pattern is not limited thereto.

### Second Embodiment

The second embodiment of the invention is now explained. In this embodiment, the configuration of the game machine (refer to FIG. 1), relationship of the object, light source, and viewpoint arranged in the virtual three-dimensional space (refer to FIG. 2), and the overall flow of image processing (rendering processing) are the same as the first embodiment, and the explanation thereof is omitted. The processing for expressing the canvas pattern is now explained. Incidentally, with the processing explained below, the processing sequence may be switched or the respective processing steps may be performed in parallel so as long as there is no inconsistency in the processing result.

FIG. 9 is a flowchart showing the flow of image processing to be executed by the game machine of the second embodiment. Steps that overlap with the first embodiment will be omitted as appropriate.

The CPU 10 arranges an object (polygon model) configured by combining a plurality of polygons in the virtual three-dimensional space based on the data read from the system memory 11 (step S20).

The CPU 10 additionally sets the light source and the viewpoint, and the GPU 16 generates basic image data according to the settings configured by the CPU 10 (step S21). Details of the processing at step S21 are the same as step S11 in the first embodiment. The obtained basic image data (refer to FIG. 4) is stored in a frame buffer (first storage area) set in the graphic memory 17.

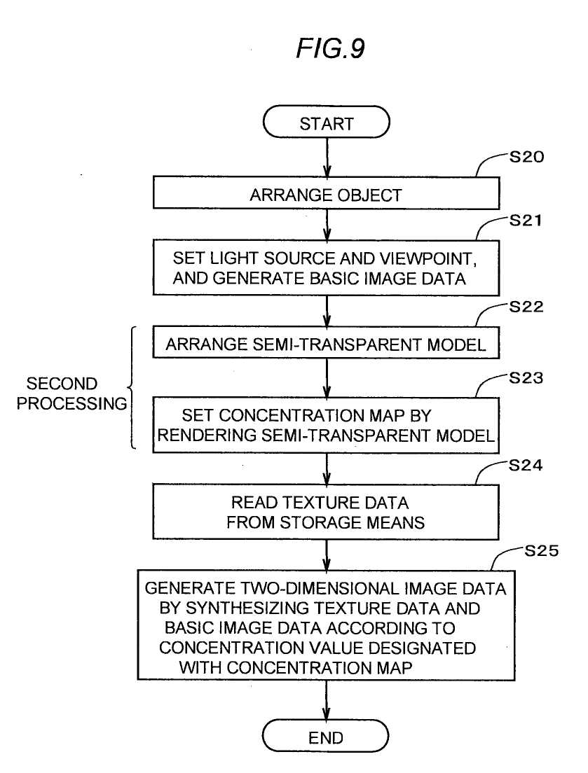

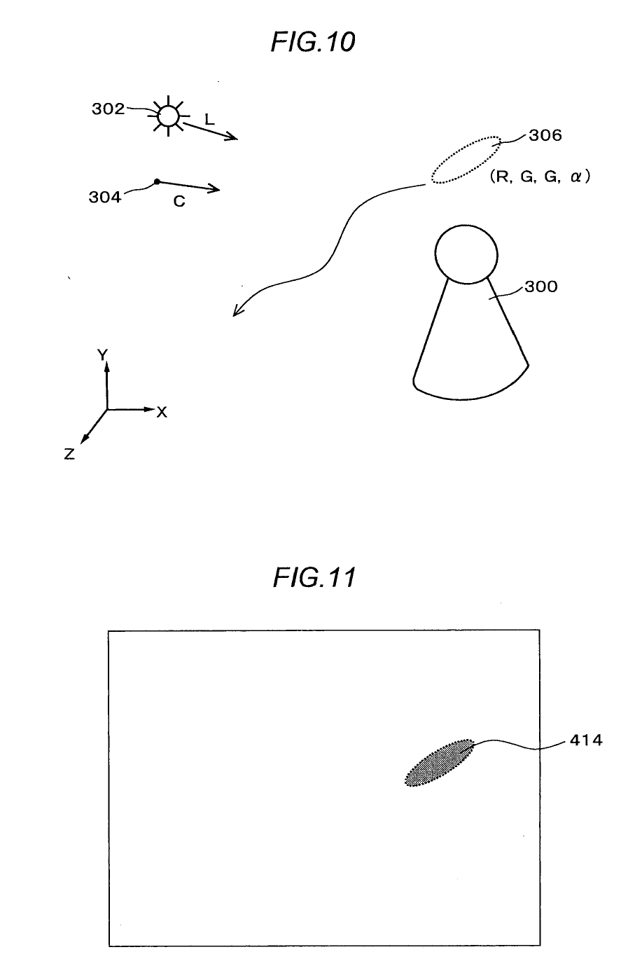

Subsequently, the CPU 10 arranges a semi-transparent model associated with the concentration value in the virtual three-dimensional space based on data read from the system memory 11 (step S22). FIG. 10 is a view showing a frame format explaining the processing contents of step S22. As described above, the semi-transparent model 306 is arranged in the virtual three-dimensional space in which the object 300, the light source 302, and the viewpoint 304 are set. The semi-transparent model is configured, for instance, using one or more polygons. Each polygon can be set with information concerning the respective colors of R, G, and B, and an α value (alpha value) as additional information. In this embodiment, the concentration value is set as the α value (additional information). The concentration value is set, for example, within a numerical value range of 0.0 to 1.0. A concentration value of 0.0 represents non-transmittance (opaque), a concentration value of 1.0 represents total transmittance (transparent), and a concentration value in between represents partial transmittance (semi transparent). By using the α value, it is possible to prepare a semi-transparent model associated with the concentration value. Incidentally, the method of using the α value is merely one example of a method of associating the concentration value with the semi-transparent model.

Here, as shown in FIG. 10, the position of the semi-transparent model 306 can be set by occasionally changing the setting in coordination with a prescribed processing timing (for instance, each frame in the creation of a moving image). Consequently, it will be possible to express, for example, the appearance of the blowing wind using a canvas pattern. An example of this image will be described later.

Subsequently, the GPU 16 sets the concentration map by rendering the semi-transparent model arranged in the virtual three-dimensional space at step S22 (step S23). FIG. 11 is a diagram visually expressing the concentration map set at step S23. In FIG. 11, the concentration map is set in the colored region. Specifically, by performing rendering, the partial region 414 (oval region in the illustration) of the basic image data is demarcated in correspondence with the shape of the semi-transparent model, and the concentration value associated with this partial region is designated. The set concentration map is stored in a texture buffer (second storage area) set in the graphic memory 17.

Subsequently, the GPU 16 reads texture data from the storage medium 12 (step S24). An example of texture data is as shown in FIG. 6.

Subsequently, the GPU 16 generates two-dimensional image data by synthesizing the texture data read at step S23 with the basic image data at a ratio according to the concentration value set with the concentration map set at step S23 (step S25). The generated two-dimensional image data is stored in a frame buffer set in the graphic memory 17.

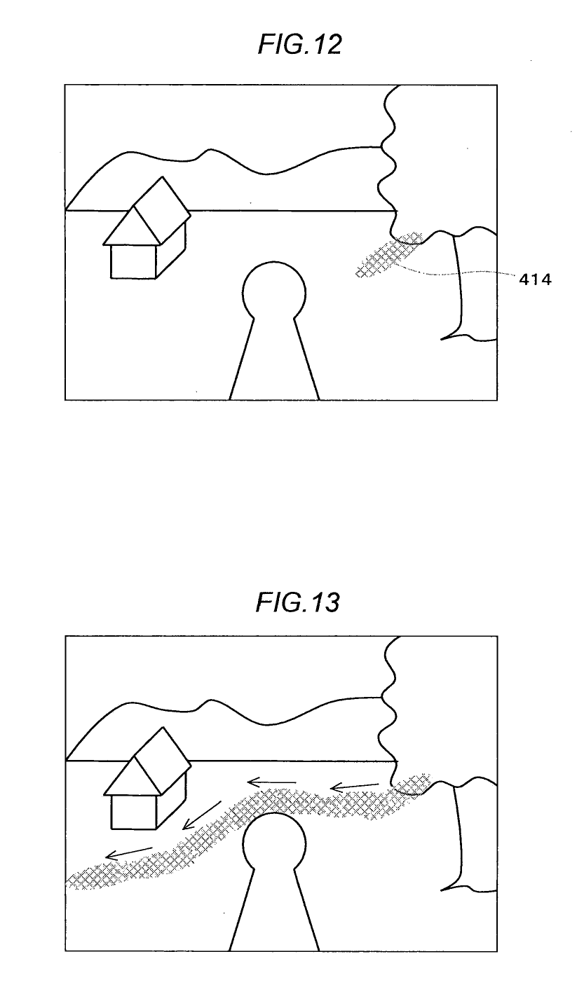

FIG. 12 is a diagram showing the appearance when texture data and basic image data are synthesized at a ratio according to the concentration value. Texture is synthesized in the partial region 414 near the center of the basic image data. The basic image is transmissive at a ratio according to the concentration value, and the texture is also semi transparent. If the user wishes to display the texture more thickly (darkly), the user sets the concentration value closer to 1.0. Consequently, since the transmittance of the basic image will decrease and the texture will be displayed more darkly, it is possible to enhance the unpainted feeling. If the concentration value is set to 1.0, since the texture data will be mixed at a ratio of 100% and the basic image data will be mixed at a ratio of 0%, the result will be that the basic image will not be transmissive and only the texture will be displayed. Here, the unpainted feeling in the annular region 414 will be accentuated the strongest. Meanwhile, if the user wishes to display the texture more thinly (lightly), the user sets the concentration value closer to 0.0. Consequently, since the transmittance of the basic image will increase and the texture will be displayed more lightly, the unpainted feeling will weaken. In other words, by appropriately setting the concentration value, it is possible to control the blend ratio of the texture data including the canvas pattern to the basic image data, and thereby freely control the unpainted feeling. In addition, by repeating the processing shown in FIG. 9 at a prescribed timing, it is possible to generate a moving image in which the unpainted feeling that changes occasionally in accordance with the respective scenes.

FIG. 13 is a diagram explaining a display image in a case of continually moving the position of the semi-transparent model. As shown in FIG. 13, by reading data for continually changing the position coordinate or concentration value of the semi-transparent model in the virtual three-dimensional space from the system memory 11 or the storage medium 12, movement of the unpainted portion or changes in the concentration can be expressed in the moving image. This expression is suitable, for instance, when expressing the blowing of the wind.

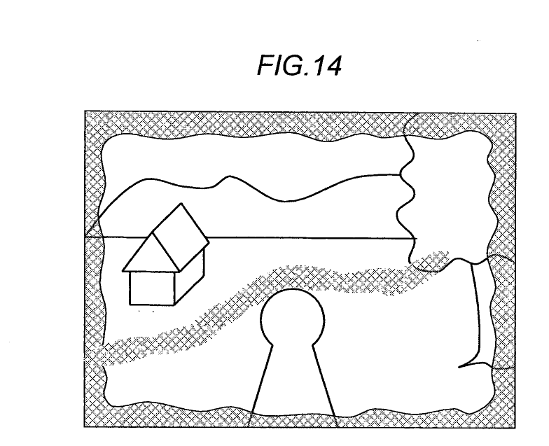

Incidentally, by performing the first processing (FIG. 3; step S13) in the first embodiment in conjunction with the second processing (FIG. 9; step S22, S23) in the second embodiment, an expression combining the effects of the first and second embodiments can be realized (refer to FIG. 14).

### Third Embodiment

The third embodiment of the invention is now explained. In this embodiment, the configuration of the game machine (refer to FIG. 1), relationship of the object, light source, and viewpoint arranged in the virtual three-dimensional space (refer to FIG. 2), and the overall flow of image processing (rendering processing) are the same as the first embodiment, and the explanation thereof is omitted. The processing for expressing the canvas pattern is now explained. Incidentally, with the processing explained below, the processing sequence may be switched or the respective processing steps may be performed in parallel so as long as there is no inconsistency in the processing result.

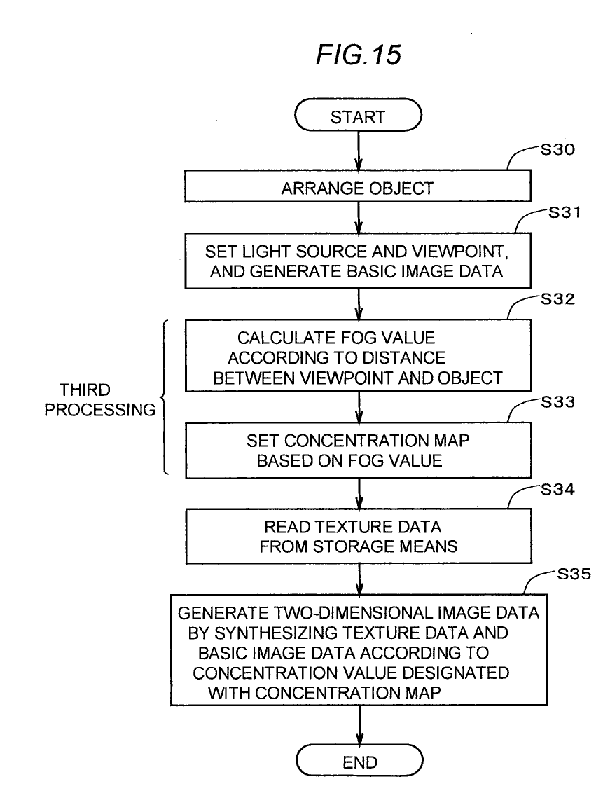

FIG. 15 is a flowchart showing the flow of image processing to be executed by the game machine of the third embodiment. Steps that overlap with the first embodiment will be omitted as appropriate.

The CPU 10 arranges an object (polygon model) configured by combining a plurality of polygons in the virtual three-dimensional space based on the data read from the system memory 11 (step S30).

The CPU 10 additionally sets the light source and the viewpoint, and the GPU 16 generates basic image data according to the settings configured by the CPU 10 (step S31). Details of the processing at step S31 are the same as step S11 in the first embodiment. The obtained basic image data (refer to FIG. 4) is stored in a frame buffer (first storage area) set in the graphic memory 17.

Subsequently, the GPU 16 calculates a fog value according to the distance between the viewpoint position (camera position; refer to FIG. 2) and the object (step S32). More specifically, for instance, the distance between the apex of the polygons configuring the respective objects and the viewpoint is calculated, and the fog value is calculated according to the calculated distance. Here, “fog” is an expression (simulation) of a fog in the virtual three-dimensional space, and specifically represents the transparency of the space.

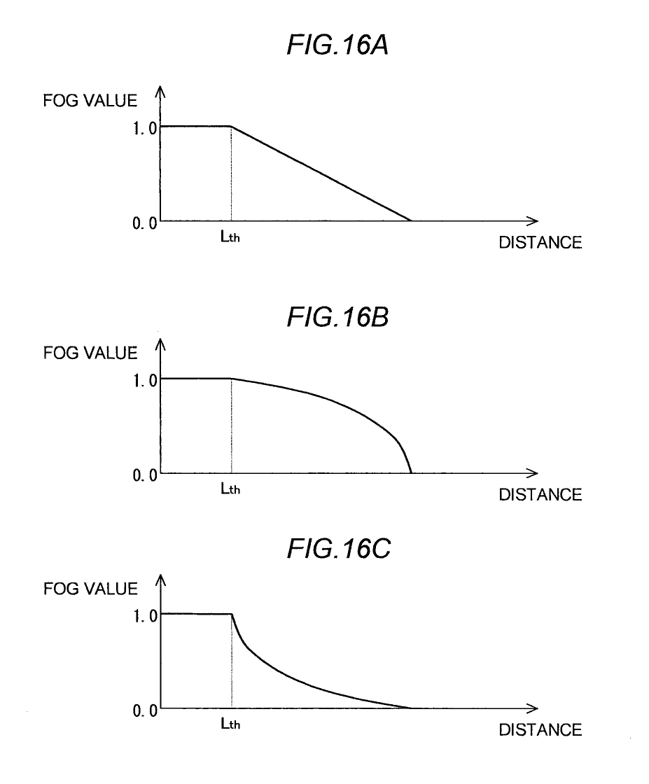

The fog value is now explained with reference to FIG. 16. The fog value, for instance, is a parameter having a numerical value range of 0.0 to 1.0. The closer the distance between the object and the viewpoint, the greater the fog value, and there will be no fog when the fog value=1.0. In other words, the transparency will increase. Contrarily, the farther the distance between the object and the viewpoint, the smaller the fog value, and the image will be completely obscured by fog when the fog value=0.0. In other words, the transparency will decrease. For instance, in the example of FIG. 16A, the fog value will uniformly=1.0 when the distance is smaller than a certain threshold value Lₜₕ, the fog value will decrease according to the increasing distance when the distance exceeds the threshold value Lₜₕ, and the fog value=0.0 upon reaching a certain distance. Here, the relationship of the distance and the fog value will change linearly in FIG. 16A, the relationship may also change non-linearly as shown in FIG. 16B and FIG. 16C. For instance, in the example shown in FIG. 16B, the fog value decreases relatively gradually in relation to the increase in distance, and the fog value suddenly decreases when the distance increases a certain degree. Moreover, in the example shown in FIG. 16C, the fog value decreases relatively suddenly in relation to the increase in distance, and the decrease in the fog value becomes gradual when the distance increases a certain degree. Incidentally, the threshold value Lₜₕ regarding the distance is an arbitrary item, and does not necessary have to be set. By setting the threshold value Lₜₕ, it is possible to prevent the object (for instance, a core target to be drawn such as a human character) that is fairly close to the viewpoint from being covered by any fog.

Subsequently, the GPU 16 calculates the concentration map based on the fog value calculated at step S32 (step S33). In this embodiment, a value obtained by subtracting the fog value calculated at step S32 from 1.0 (1.0—fog value) is used as the concentration value. Incidentally, the concentration value may also be set by adjusting the fog value as needed such as by multiplying a prescribed constant. The concentration map set based on this fog value is stored in a texture buffer (second storage area) set in the graphic memory 17.

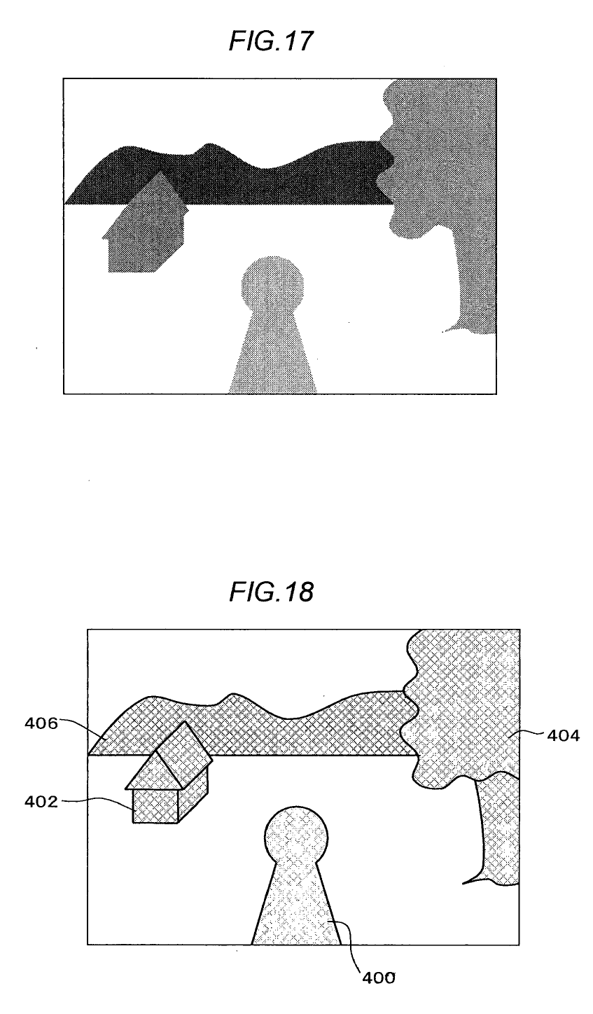

FIG. 17 is a diagram visually expressing the concentration map set at step S33. In FIG. 17, the concentration map is set in the region colored with grayscale. The darker the region, the greater the concentration value.

Subsequently, the GPU 16 reads texture data from the storage medium 12 (step S34). An example of texture data is as shown in FIG. 6.

Subsequently, the GPU 16 generates two-dimensional image data by synthesizing the texture data read at step S34 with the basic image data at a ratio according to the concentration value set with the concentration map set at step S33 (step S35). The generated two-dimensional image data is stored in a frame buffer set in the graphic memory 17.

FIG. 18 is a diagram showing the appearance when texture data and basic image data are synthesized at a ratio according to the concentration value. The fog value is calculated according to the distance between each object (character, building, tree, distant view) and the viewpoint, and the concentration map is set based on the calculated fog value. Consequently, the basic image is transmissive at a ratio according to the concentration value regarding the character image 400, the building image 402, the tree image 404, and the distant view image 406, and the texture is also semi transparent. The transparency level of the texture is greater; that is, that texture looks darker for images corresponding to an object that is farther from the viewpoint (for instance, refer to the distant view image 406), and the transparency level of the texture is smaller; that is, the texture looks lighter for images corresponding to an object that is closer from the viewpoint (for instance, refer to the character image 400). As described above, by using the fog value to set the concentration map, it is possible to control the blend ratio of the texture data including the canvas pattern to the basic image data according to the distance from the viewpoint, and thereby present an unpainted feeling. This expression matches the general tendency in actual water-color paintings where the unpainted feeling is smaller regarding close objects since they are expressed more delicately, and the unpainted feeling is greater regarding far objects. In addition, by repeating the processing shown in FIG. 15 at a prescribed timing, it is possible to generate a moving image in which the unpainted feeling that changes occasionally in accordance with the respective scenes.

### Fourth Embodiment

The fourth embodiment of the invention is now explained. In this embodiment, the configuration of the game machine (refer to FIG. 1), relationship of the object, light source, and viewpoint arranged in the virtual three-dimensional space (refer to FIG. 2), and the overall flow of image processing (rendering processing) are the same as the first embodiment, and the explanation thereof is omitted. The processing for expressing the canvas pattern is now explained. Incidentally, with the processing explained below, the processing sequence may be switched or the respective processing steps may be performed in parallel so as long as there is no inconsistency in the processing result.

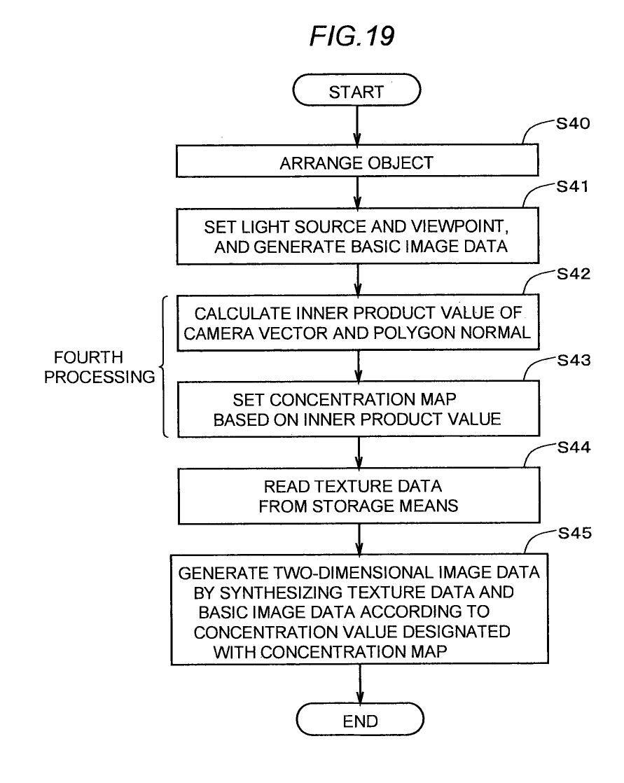

FIG. 19 is a flowchart showing the flow of image processing to be executed by the game machine of the fourth embodiment. Steps that overlap with the first embodiment will be omitted as appropriate.

The CPU 10 arranges an object (polygon model) configured by combining a plurality of polygons in the virtual three-dimensional space based on the data read from the system memory 11 (step S40).

The CPU 10 additionally sets the light source and the viewpoint, and the GPU 16 generates basic image data according to the settings configured by the CPU 10 (step S41). Details of the processing at step S41 are the same as step S11 in the first embodiment. The obtained basic image data (refer to FIG. 4) is stored in a frame buffer (first storage area) set in the graphic memory 17.

Subsequently, the GPU 16 calculates the inner product value of the camera vector C (refer to FIG. 2) and the normal of the respective polygons configuring the object (step S42).

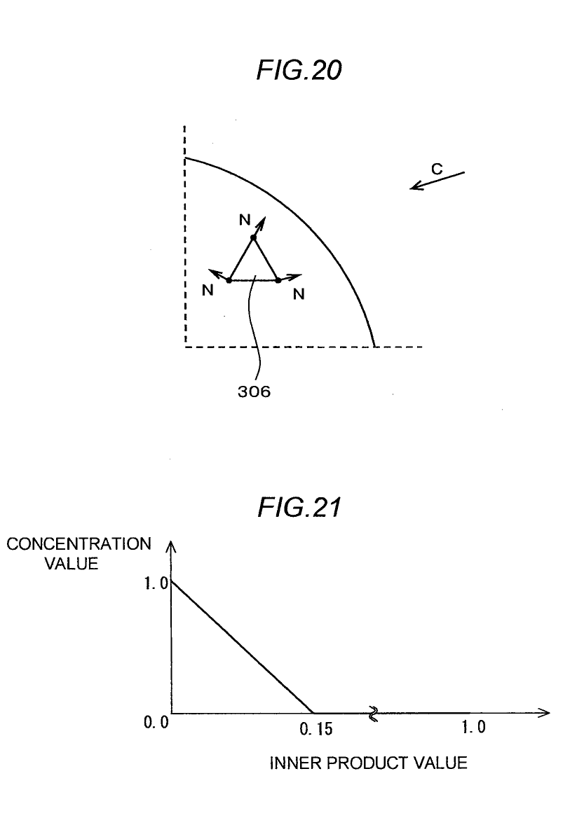

Here, the relationship of the respective polygons configuring the object and the camera vector is explained with reference to the conceptual diagram shown in FIG. 20. In FIG. 20, one polygon 306 is shown as a representation of a plurality of polygons configuring the object 300. The polygon 306 is a triangular fragment having three apexes as shown in FIG. 20. The polygon may also be other polygonal shapes (for instance, a square). A normal vector N is set to the respective apexes of the polygon 306. The length of these normal vectors N is normalized to 1. These normal vectors N may also be arbitrarily set at a location other than the apexes of the polygon; for instance, on a plane demarcated with the respective apexes. In this embodiment, the inner product value of the respective normal vectors N and the light vector C is used as the parameter. With this inner product value, since both the normal vector N and the camera vector C are normalized to 1, the cosine of the angle θ formed by the normal vector N and the camera vector C will become cos θ, and the value thereof will be within the range of −1 to +1.

Subsequently, the GPU 16 sets the concentration map based on the inner product value calculated at step S42 (step S43). In this embodiment, prescribed data conversion is performed to the inner product value, and the value obtained by the data conversion is used as the concentration value. The term “data conversion” refers to the conversion of the inner product value according to a given rule so that the greater the angle θ formed with the normal vector N and the camera vector C (in other words, smaller the inner product value), the greater the concentration value, and the concentration value becomes a maximum value when θ=90° (in other words, when the inner product value is 0). The concentration map set based on the inner product value is stored in a texture buffer (second storage area) set in the graphic memory 17.

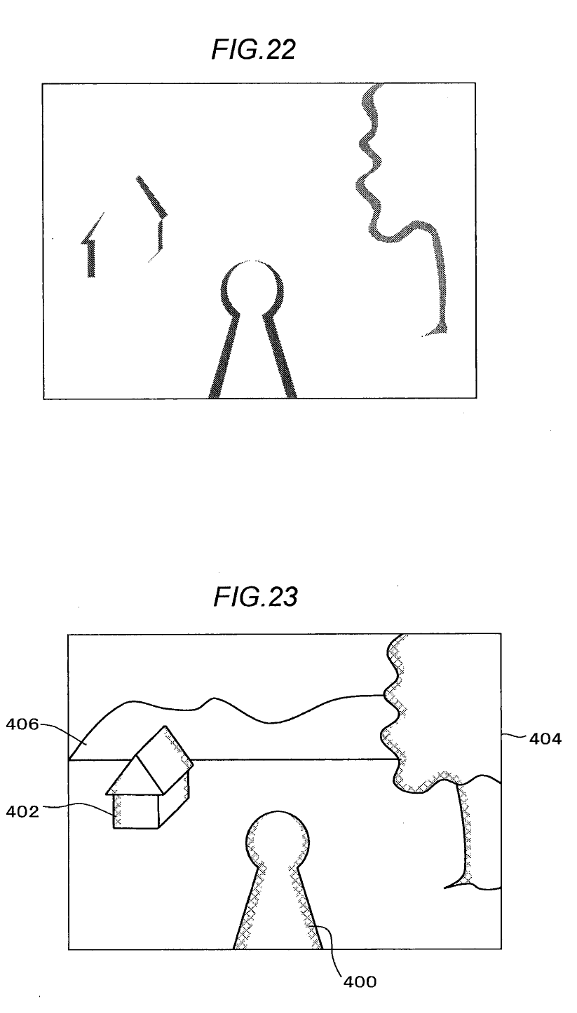

FIG. 21 is a diagram explaining a specific example of data conversion. As shown in FIG. 21, the foregoing data conversion can be realized by performing interpolation such that the concentration value is 1.0 when the inner product value is 0, the concentration value is 0.0 when the inner product value is a prescribed upper limit value (0.15 in the example of FIG. 21), and the concentration value in between (concentration value is between 0 to 0.15 in the example of FIG. 21) changes linearly. Here, the concentration value is uniformly 0.0 regarding the portions in which the inner product value exceeds a prescribed value. Incidentally, non-linear interpolation may be performed in substitute for the foregoing linear interpolation. By adjusting the upper limit value, it will be possible to freely decide the scope of the range in which the concentration value has a greater value than 0.0 (refer to FIG. 22 described later). This upper limit value is not a requisite item in data conversion. As a more simple data conversion, for instance, an arithmetic operation of (1.0−inner product value)=concentration value may also be adopted.

FIG. 22 is a diagram visually expressing the concentration map to be set at step S43. In FIG. 22, the concentration map is set in the region colored with grayscale. Although it is difficult to fully express this in FIG. 22, as a result of the angle θ formed by the normal vector N and the camera vector C at the outer part of the object approaching 90°, the concentration value of such portion can be increased. In addition, by setting the foregoing upper limit value and subjecting the inner product value to data conversion, the region having a concentration value of 0.0 or greater can be limited to a location where the angle θ formed with the camera vector C and the normal vector N is relatively large.

Subsequently, the GPU 16 reads texture data from the storage medium 12 (step S44). An example of texture data is as shown in FIG. 6.

Subsequently, the GPU 16 generates two-dimensional image data by synthesizing the texture data read at step S44 with the basic image data at a ratio according to the concentration value set with the concentration map set at step S43 (step S45). The generated two-dimensional image data is stored in a frame buffer set in the graphic memory 17.

FIG. 23 is a diagram showing the appearance when texture data and basic image data are synthesized at a ratio according to the concentration value. The concentration map is set based on the inner product value of the normal vector of the polygons of each object (character, building, tree, distant view) and the camera vector. Consequently, the basic image is transmissive at a ratio according to the concentration value regarding the character image 400, the building image 402, and the tree image 404, and the texture is also semi transparent. The greater the angle formed with the normal vector and the camera vector (that is, the smaller the inner product value), the greater the transparency level of the texture; that is, the texture will look darker. The outside (outer periphery) of the respective objects will be accentuated. As described above, by using the inner product value to set the concentration map, it is possible to control the blend ratio of the texture data including the canvas pattern to the basic image data according to the angle formed with the camera vector (viewpoint) and the object surface, and thereby present an unpainted feeling. This expression matches the general tendency in actual water-color paintings where the unpainted feeling is smaller regarding close objects since they are expressed more delicately, and the unpainted feeling is greater regarding far objects. In addition, by repeating the processing shown in FIG. 19 at a prescribed timing, it is possible to generate a moving image in which the unpainted feeling that changes occasionally in accordance with the respective scenes.

### Fifth Embodiment

The image processing explained in each of the first to fourth embodiments may also be performed in combination. This is described in detail below. In this embodiment, the configuration of the game machine (refer to FIG. 1), relationship of the object, light source, and viewpoint arranged in the virtual three-dimensional space (refer to FIG. 2), and the overall flow of image processing (rendering processing) are the same as the first embodiment, and the explanation thereof is omitted. The processing for expressing the canvas pattern is now explained. Incidentally, with the processing explained below, the processing sequence may be switched or the respective processing steps may be performed in parallel so as long as there is no inconsistency in the processing result.

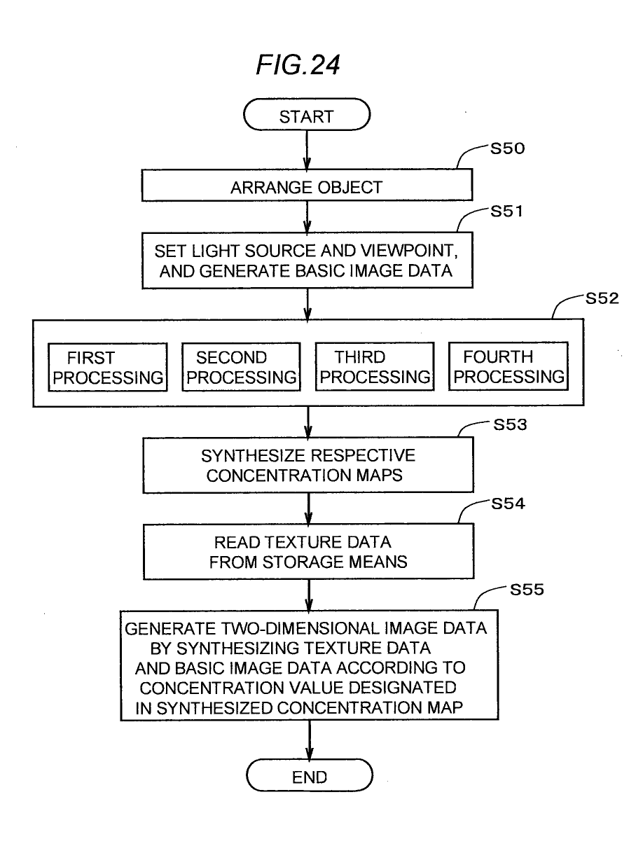

FIG. 24 is a flowchart showing the flow of image processing to be executed by the game machine of the fifth embodiment. Steps that overlap with the first embodiment will be omitted as appropriate.

The CPU 10 arranges an object (polygon model) configured by combining a plurality of polygons in the virtual three-dimensional space based on the data read from the system memory 11 (step S50).

The CPU 10 additionally sets the light source and the viewpoint, and the GPU 16 generates basic image data according to the settings configured by the CPU 10 (step S51). Details of the processing at step S51 are the same as step S11 in the first embodiment. The obtained basic image data (refer to FIG. 4) is stored in a frame buffer (first storage area) set in the graphic memory 17.

Subsequently, the GPU 16 respectively performs the first processing (refer to FIG. 3; step S13) in the first embodiment, the second processing (refer to FIG. 9; steps S22, 23) in the second embodiment, the third processing (refer to FIG. 3; steps S32, 33) in the third embodiment, and the fourth processing (refer to FIG. 3; steps S42, 43) in the fourth embodiment (step S52). Details regarding the first processing to fourth processing have been described above, and the detailed explanation thereof is omitted. To explain this briefly, the first processing is processing for setting the concentration map using prepared fixed data, the second processing is processing for setting the concentration map using a semi-transparent model, the third processing is processing for setting the concentration map using a fog value, and the fourth processing is processing for setting the concentration map using the inner product value of the camera vector and the polygon normal.

At step S52, it will suffice so as long as at least two processing routines among the first processing, the second processing, the third processing, and the fourth processing are performed. The combination of these processing routines is arbitrary.

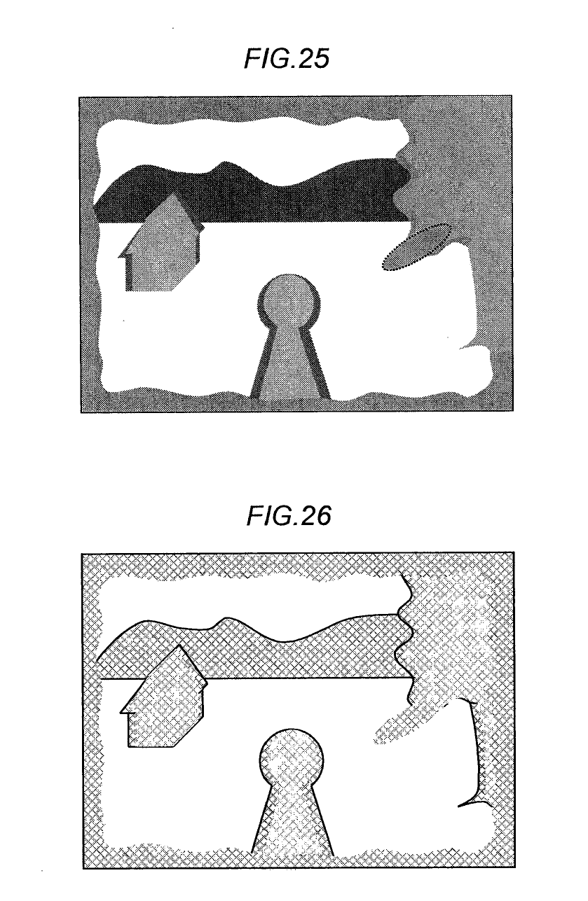

Subsequently, the GPU 16 synthesizes the concentration maps set based on the respective first to fourth processing routines (when any one of the processing routines is selectively executed, the selected processing routine) (step S53). Specifically, the concentration value is compared for each pixel regarding the concentration maps obtained with each of the foregoing processing routines, and the highest concentration value is selected for each pixel. FIG. 25 visually shows the concentration map (synthesized concentration map) obtained based on the foregoing synthesizing processing.

The synthesizing method of the concentration map at step S53 is not limited to the foregoing method. For example, the concentration value may be compared for each pixel regarding the concentration maps obtained based on each of the first to fourth processing routines, and the lowest concentration value may be selected for each pixel, or the concentration value based on the first to fourth processing routines may be averaged for each pixel. Moreover, a certain concentration map obtained from one of the processing routines may be used preferentially to the other concentration maps. For example, preferably, the concentration map of the first processing is preferentially used.

Subsequently, the GPU 16 reads texture data from the storage medium 12 (step S54). An example of texture data is as shown in FIG. 6.

Subsequently, the GPU 16 generates two-dimensional image data by synthesizing the texture data read at step S54 with the basic image data at a ratio according to the concentration value set with the concentration map set at step S53 (step S55). The generated two-dimensional image data is stored in a frame buffer set in the graphic memory 17.

FIG. 26 is a diagram showing the appearance when texture data and basic image data are synthesized at a ratio according to the concentration value, and shows the combined results of each of the first to fourth processing routines.

### MODIFIED EXAMPLE

Incidentally, the invention is not limited to the subject matter of the respective embodiments described above, and may be implemented in various modifications within the scope of the gist of this invention. For example, although the foregoing embodiments realized a game machine by causing a computer including hardware such as a CPU to execute prescribed programs, the respective function blocks provided to the game machine may also be realized using dedicated hardware or the like.

In addition, although the foregoing embodiments explained the image processing apparatus, the image processing method and the image processing program by taking a game machine as an example, the scope of the invention is not limited to a game machine. For instance, the invention can also be applied to a similar device that simulatively reproduces various experiences (for instance, driving operation) of the real world.

### Reference: Technical Concept

A part of the technical concept of the foregoing embodiments is additionally indicated below.

An image processing program according to one aspect of the invention is executed by an image processing apparatus comprising a memory and a processor, and is a program for generating two-dimensional image data obtained by performing perspective projection to a virtual three-dimensional space on a prescribed perspective projection plane. This program causes the processor to perform processes of (a) arranging a viewpoint in the virtual three-dimensional space, generating basic image data by performing perspective projection on the perspective projection plane set in correspondence to the viewpoint, and storing the basic image data in the memory, (b) calculating a fog value representing the transparency of the virtual three-dimensional space according to the distance between the position of the viewpoint and an object arranged in the virtual three-dimensional space, (c) setting a concentration map showing a concentration value associated with the basic image data based on the fog value, and storing the concentration map in the memory, (d) reading texture data from the memory, and (e) generating the two-dimensional image data by synthesizing the texture data with the basic image data at a ratio according to the concentration value set with the concentration map. Here, as the texture data, for example, texture data including an image of a canvas pattern is used.

Preferably, at (b), the fog value is set to a constant value if the distance between the viewpoint and the object is less than a prescribed threshold value.

Preferably, at (c), the concentration map is set by using the fog value as is as the concentration value.

An image processing program according to another aspect of the invention is executed by an image processing apparatus comprising a memory and a processor, and is a program for generating two-dimensional image data obtained by performing perspective projection to a virtual three-dimensional space on a prescribed perspective projection plane. This program causes the processor to perform processes of (a) arranging a viewpoint in the virtual three-dimensional space, generating basic image data by performing perspective projection on the perspective projection plane set in correspondence to the viewpoint, and storing the basic image data in the memory, (b) calculating an inner product value of a camera vector showing the direction of the viewpoint and a normal vector of polygons of an object arranged in the virtual three-dimensional space, (c) setting a concentration map showing a concentration value associated with the basic image data based on the inner product value, and storing the concentration map in the memory, (d) reading texture data from the memory, and (e) generating the two-dimensional image data by synthesizing the texture data with the basic image data at a ratio according to the concentration value set with the concentration map. Here, as the texture data, for example, texture data including an image of a canvas pattern is used.

Preferably, at (c), data conversion is performed to the inner product value so that smaller the inner product value, greater the concentration value, and the concentration value becomes a maximum value when the inner product value is 0, and the concentration map is set based on a concentration value obtained based on the data conversion.

A computer-readable recording medium according to a further aspect of the invention is a recording medium recording the foregoing program of the invention. As described below, the invention can also be expressed as an image processing apparatus or an image processing method.

An image processing apparatus according to a still further aspect of the invention comprises a memory and a processor, and is an image processing apparatus for generating two-dimensional image data obtained by performing perspective projection to a virtual three-dimensional space on a prescribed perspective projection plane. With this image processing apparatus, the processor functions respectively as (a) a unit that arranges a viewpoint in the virtual three-dimensional space, generates basic image data by performing perspective projection on the perspective projection plane set in correspondence to the viewpoint, and stores the basic image data in the memory, (b) a unit that calculates a fog value representing the transparency of the virtual three-dimensional space according to the distance between the position of the viewpoint and an object arranged in the virtual three-dimensional space, (c) a unit that sets a concentration map showing a concentration value associated with the basic image data based on the fog value, and stores the concentration map in the memory, (d) a unit that reads texture data from the memory, and (e) a unit that generates the two-dimensional image data by synthesizing the texture data with the basic image data at a ratio according to the concentration value set with the concentration map.

An image processing apparatus according to a still further aspect of the invention comprises a memory and a processor, and is an image processing apparatus for generating two-dimensional image data obtained by performing perspective projection to a virtual three-dimensional space on a prescribed perspective projection plane. With this image processing apparatus, the processor functions respectively as (a) a unit that arranges a viewpoint in the virtual three-dimensional space, generates basic image data by performing perspective projection on the perspective projection plane set in correspondence to the viewpoint, and stores the basic image data in the memory, (b) a unit that calculates an inner product value of a camera vector showing the direction of the viewpoint and a normal vector of polygons of an object arranged in the virtual three-dimensional space, (c) a unit that sets a concentration map showing a concentration value associated with the basic image data based on the inner product value, and stores the concentration map in the memory, (d) a unit that reads texture data from the memory, and (e) a unit that generates the two-dimensional image data by synthesizing the texture data with the basic image data at a ratio according to the concentration value set with the concentration map.

An image processing method according to a still further aspect of the invention is an image processing method of generating two-dimensional image data obtained by performing perspective projection to a virtual three-dimensional space with an object arranged therein on a prescribed perspective projection plane in an image processing apparatus comprising a memory and a processor. With this image processing method, the processor performs processes of (a) arranging a viewpoint in the virtual three-dimensional space, generating basic image data by performing perspective projection on the perspective projection plane set in correspondence to the viewpoint, and storing the basic image data in the memory, (b) calculating a fog value representing the transparency of the virtual three-dimensional space according to the distance between the position of the viewpoint and an object arranged in the virtual three-dimensional space, (c) setting a concentration map showing a concentration value associated with the basic image data based on the fog value, and storing the concentration map in the memory, (d) reading texture data from the memory, and (e) generating the two-dimensional image data by synthesizing the texture data with the basic image data at a ratio according to the concentration value set with the concentration map.

An image processing method according to a still further aspect of the invention is an image processing method of generating two-dimensional image data obtained by performing perspective projection to a virtual three-dimensional space with an object arranged therein on a prescribed perspective projection plane in an image processing apparatus comprising a memory and a processor. With this image processing method, the processor performs processes of (a) arranging a viewpoint in the virtual three-dimensional space, generating basic image data by performing perspective projection on the perspective projection plane set in correspondence to the viewpoint, and storing the basic image data in the memory, (b) calculating an inner product value of a camera vector showing the direction of the viewpoint and a normal vector of polygons of an object arranged in the virtual three-dimensional space, (c) setting a concentration map showing a concentration value associated with the basic image data based on the inner product value, and storing the concentration map in the memory, (d) reading texture data from the memory, and (e) generating the two-dimensional image data by synthesizing the texture data with the basic image data at a ratio according to the concentration value set with the concentration map.

What is claimed is:

1. A program that is executed by an image processing apparatus comprising a memory and a processor, and which generates two-dimensional image data obtained by performing perspective projection to a virtual three-dimensional space on a prescribed perspective projection plane,
wherein the program causes the processor to perform processes of:
(a) arranging a viewpoint in the virtual three-dimensional space, generating basic image data by performing perspective projection on the perspective projection plane set in correspondence to the viewpoint, and storing the basic image data in the memory;
(b) setting a concentration map showing a concentration value associated with a partial region of the basic image data, and storing the concentration map in the memory;
(c) reading texture data from the memory; and
(d) generating the two-dimensional image data by synthesizing the texture data with the basic image data at a ratio according to the concentration value set with the concentration map.

2. The program according to claim 1,
wherein, at (b), data that demarcates the partial region and designates the concentration value of the partial region is read from the memory, and the concentration map is set based on the read data.

3. The program according to claim 1,
wherein, at (b), the concentration map that demarcates the partial region and designates the concentration value of the partial region is set by arranging a semi-transparent model associated with the concentration value in the virtual three-dimensional space and rendering the semi-transparent model.

4. The program according to claim 1,
wherein the texture data includes an image of a canvas pattern.

5. A computer-readable recording medium recording the program according to claim 1.

6. An image processing apparatus comprising a memory and a processor, and which generates two-dimensional image data obtained by performing perspective projection to a virtual three-dimensional space on a prescribed perspective projection plane,
wherein the processor functions respectively as:
(a) a unit that arranges a viewpoint in the virtual three-dimensional space, generates basic image data by performing perspective projection on the perspective projection plane set in correspondence to the viewpoint, and stores the basic image data in the memory;
(b) a unit that sets a concentration map showing a concentration value associated with a partial region of the basic image data, and stores the concentration map in the memory;
(c) a unit that reads texture data from the memory; and
(d) a unit that generates the two-dimensional image data by synthesizing the texture data with the basic image data at a ratio according to the concentration value set with the concentration map.

7. The image processing apparatus according to claim 6,
wherein, the unit of (b) reads data that demarcates the partial region and designates the concentration value of the partial region from the memory, and sets the concentration map based on the read data.

8. The image processing apparatus according to claim 6,
wherein, the unit of (b) sets the concentration map that demarcates the partial region and designates the concentration value of the partial region by arranging a semi-transparent model associated with the concentration value in the virtual three-dimensional space and rendering the semi-transparent model.

9. The image processing apparatus according to claim 6,
wherein the texture data includes an image of a canvas pattern.

10. An image processing method of generating two-dimensional image data obtained by performing perspective projection to a virtual three-dimensional space with an object arranged therein on a prescribed perspective projection plane in an image processing apparatus comprising a memory and a processor,
wherein the processor performs processes of:
(a) arranging a viewpoint in the virtual three-dimensional space, generating basic image data by performing perspective projection on the perspective projection plane set in correspondence to the viewpoint, and storing the basic image data in the memory;
(b) setting a concentration map showing a concentration value associated with a partial region of the basic image data, and storing the concentration map in the memory;
(c) reading texture data from the memory; and
(d) generating the two-dimensional image data by synthesizing the texture data with the basic image data at a ratio according to the concentration value set with the concentration map.

11. The image processing method according to claim 10,
wherein, at (b), data that demarcates the partial region and designates the concentration value of the partial region is read from the memory, and the concentration map is set based on the read data.

12. The image processing method according to claim 10,
wherein, at (b), the concentration map that demarcates the partial region and designates the concentration value of the partial region is set by arranging a semi-transparent model associated with the concentration value in the virtual three-dimensional space and rendering the semi-transparent model.

13. The image processing method according to claim 10,
wherein the texture data includes an image of a canvas pattern.
